(19) United States
(12) Patent Application Publication
(10) Pub. No.: US 2005/0179281 A1
(43) Pub. Date: Aug. 18, 2005

(54) Snow & ice eliminator

(76) Inventor: David E. Brown, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 10/779,046

(22) Filed: Feb. 17, 2004

(51) Int. Cl. B60J 1/20

(52) U.S. Cl. 296/95.1

(57) ABSTRACT

An improved automobile cover that prevents frost, ice or snow from freezing on a windshield. The eliminator is preferably a layer of natural open cell rubber with a polyester laminate fabric backing which covers the outside of the windshield. This would be inclusive off all similar materials such as all neoprene, closed cell, electrostatic disapative, rubber, nitrite and similar type materials with a fabric material backing. A 24″ nylon strap is affixed to the side of the eliminator for securing it to the windshield and to assist when storing during the summer months.

### CROSS-REFERENCE TO RELATED APPLICATIONS

296/95.1, 97.7, 136, 160/370.2, 150/166, 168

### INTERNATIONAL CLASS

B60J

### REFERENCES CITED [REFERENCES BY]—U.S. Patent Documents

U.S. Pat. No. 4,799,728 January, 1989 Akers et al. 296/95.

U.S. Pat. No. 5,035,460 July, 1991 Juang 296/95.

### STATEMENT REGARDING FEDERALLY SPONSORED RESEARCH

Not Applicable

### REFERENCE TO SEQUENCE LISTING

Not Applicable

### BACKGROUND OF THE INVENTION

This invention relates generally to protectors for vehicles and more specifically to exterior automotive windshield protectors.

Vehicles that used in colder climates are subject to harsh weather conditions such as ice and snow. Cars that are parked out in the winter weather can accumulate ice, snow or frost on the body of the vehicle. Before operating the automobile, the operator must remove the ice/snow/frost from the windows of the car, particularly the windshield. This procedure is typically performed with an ice scrapper and is done outside in relatively cold temperatures. It would be desirable to have a protective cover that would prevent the accumulation of ice, snow or frost on the windshield of a car. It would also be desirable if such a cover was easy to use, store, work on all automobiles, rugged and durable in construction.

Several other methods have been developed to provide exterior protection to the windshield. However unfortunately, they require modifying the vehicle on a semi-permanent basis, using magnetic strips that magnetically clamp the cover, elastic straps with hooks which attach to the body of the car, suction cups and or wing flaps that fit between the vehicles door and its frame. All the above prior art devices suffer two major deficiencies. Firstly, they can damage the vehicle by scraping the paint finish.

Secondly and more importantly, none of these devices can be installed in a convenient quick fashion to fit on the windshield with little effort. The present invention overcomes these deficiencies of prior art devices by providing an improved windshield cover that can be quickly and conveniently installed to fit snugly on a windshield.

Other deficiencies with all of the prior art are their choice of materials. Use of nylon, plastic or polyethylene and the like become brittle and stiff when subjected to colder temperatures. Once the protector has been used a couple of times, it has either been torn or the operator loses patience with its stiffness and either discards it or does not use it. Use of the aforementioned materials also requires security type systems such as flaps or wings that fit between the vehicles door and its frame.

The issue of providing security cannot be sufficiently addressed with this type of art because of the inherent nature of being external to the vehicle. However the new protector is opting for convience of installation as opposed to any type of security system.

### BRIEF SUMMARY OF THE INVENTION

The new invention is a protective cover for the windshield of an automobile. The main cover section has an area that can cover most conventional windshields. This section is placed over the exterior windshield and a strap is affixed to one corner of the cover section that is used to secure it between the drivers side door and the frame of the car. This strap is also used in the summer months to assist with storage.

Any ice, snow or frost that would normally form or fall on the windshield is accumulated by the protective cover. The driver can remove the snow/ice/frost from the windshield by merely removing the cover from the car. The protective cover is typically constructed from layer of natural open cell rubber with a polyester laminate fabric backing. This design would be inclusive off all similar materials such as all neoprene, closed cell, electrostatic dissapative, rubber, and nitrite materials with a fabric material backing, so that the snow/ice/frost can be readily removed from the cover. In the preferred embodiment the entire assembly is formed from a single piece of material of natural open cell rubber with a polyester fabric laminate backing. When not in use, the cover can be folded and stored in the trunk of the automobile.

### BRIEF DESCRIPTION OF THE SEVERAL VIEWS OF DRAWING

FIG. 1 (Drawing #463596947) is a frontal and side view of an embodiment of the invention.

### DETAILED DESCRIPTION OF THE INVENTION

For ease of illustration and description, the drawing illustrates only the pertinent features of the present invention and do not show the remaining conventional features

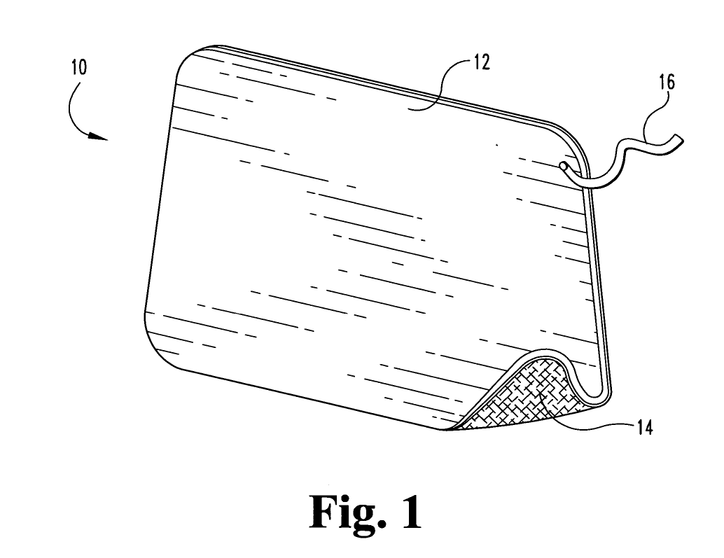

In FIG. 1 an embodiment of the invention is illustrated. The main section of the protector will be a natural open cell rubber with a polyester laminate fabric backing material which will be cut to fit any and all automotive windshields. The eliminator windshield protector design will be inclusive of all similar type materials such as neoprene, closed cell rubber, electrostatic dissipative, rubber and nitrite. The nylon rope strap is attached to the main section and is detachable depending on the operators needs. The 24″ strap is sufficiently long enough to be pulled between the open drivers side door and the frame of the vehicle. Once the door is closed this will permit the protector from becoming dislodged from the windshield by wind and or prevent from becoming lost. The other embodiment of this strap is also for storage when the main section is rolled together, the strap will hold it in storage in warmer months.

It is clear from the forgoing that this invention provides a significant improvement over the prior art of an automotive windshield screen protectors because it is considerably more convenient for the operator to use and does not damage or alter the vehicle appearance.

While the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the original scope of the invention as set forth.

1. A protective cover for a windshield of an automobile having a driver's side door, comprising:
a generally rectangular natural open cell rubber portion with a polyester laminate fabric backing and having a top edge, an oppositely disposed bottom edge, and two oppositely disposed side edges extending between the top and bottom edges; and
a flexible strap portion attached to the generally rectangular portion for holding the same on the windshield of the automobile;
wherein the strap portion is sufficiently long to extend into the automobile when the driver's side door is open;
wherein closing the driver's side door engages the strap portion;
wherein placement of the generally rectangular portion adjacent the windshield prevents frost from forming thereupon; and
wherein removal of the generally rectangular portion from the windshield exposes a substantially frost-free portion of windshield through which an automobile operator can see to operate the automobile.

2. A system for preventing the buildup of snow, ice and frost on a glass windshield of a vehicle, comprising:
a thermally insulating member having a fabric backing portion and sized to cover at least a major portion of the vehicular windshield; and
a strap portion extending from the insulating member portion for connection to the vehicle;
wherein the thermally insulating member is formed from a relatively thin sheet of thermally insulating polymer material;
wherein the thermally insulating member is characterized by an internal cellular structure;
wherein deployment of the thermally insulating member adjacent the windshield prevents accumulation of ice on the windshield;
wherein removal of the thermally insulating member reveals a substantially clear portion of the windshield; and
wherein the substantially clear portion is sufficiently large to allow operation of the vehicle.

3. The system of claim 2 wherein the insulating member is made of neoprene.

4. The system of claim 2 wherein the insulating member is made of open cell rubber.

5. The system of claim 2 wherein the insulating member is made of closed cell rubber.

6. A device for preventing the accumulation of snow, ice and frost on a glass windshield of a vehicle, comprising:
a thermally insulating polymer member sized to adjacently cover a portion of the glass windshield;
a fabric backing layer affixed adjacent the thermally insulating polymer member; and
a strap portion extending from the insulating member portion for connection to the vehicle;
wherein the thermally insulating member is at least about 3/16 of an inch thick;
wherein the thermally insulating member has an area of at least about 6 square feet;
wherein covering the windshield with the thermally insulating member prevents accumulation of ice on the windshield;
wherein removal of the thermally insulating member reveals a substantially clear portion of the windshield; and
wherein the substantially clear portion of the windshield has an area of at least about 6 square feet.

7. The system of claim 6 wherein the thermally insulating member is made of neoprene.
